(19) United States
(12) Patent Application Publication
(10) Pub. No.: US 2014/0069765 A1
(43) Pub. Date: Mar. 13, 2014

(54) AUTO-LOCKUP AND ANTI-LOCK DEVICE FOR ROTARY MECHANISM

(71) Applicant: Ta-Pin Liu, Kaohsiung City (TW)

(72) Inventor: Ta-Pin Liu, Kaohsiung City (TW)

(21) Appl. No.: 13/610,843

(22) Filed: Sep. 11, 2012

(51) Int. Cl. F16D 11/02

(52) U.S. Cl. 192/71

(57) ABSTRACT

An auto-lockup and anti-lock device for rotary mechanism applied to beach buggy, golf cart, electric cart and any other rotary devices includes a rotor, stator, stopper arranged to the stator for travelling between a lock and release position against the rotor, a clutch serving to control the stopper, and an anti-lock unit for disabling the stopper during an incident power off. The clutch is activated to drive the stopper away to disengage and release the rotor during power on. The clutch will release the stopper so that the stopper can engage and lock the rotor after power off. The anti-lock will move to block the stopper from engaging the rotor while the rotational speed of the rotor exceeding a predetermined value. The anti-lock will release the stopper automatically while the rotational speed of the rotor dropping below the predetermined value.

### FIELD OF THE INVENTION

The present invention relates to rotary mechanism lock, and particular to a lock capable of lock the rotary mechanism during power off and providing an anti-lock function for an incident power off which can be applied to beach buggy, golf cart, electric cart, and any other devices requiring for the functions.

### DESCRIPTION OF THE PRIOR ART

Rotary mechanisms of a beach buggy, golf cart, electric cart, and other devices usually need an auxiliary hand brake to prevent further movement after shutdown. Such hand brake needs to be handled by the user so that the vehicles can be damaged by the undesirable slide when the manual operation is ignored.

Therefore, it is important to create a rotary mechanism lock which can lock and release the rotary mechanism automatically by the direct power off and power on respectively. The rotary mechanism can be released for operation and locked for protection by simply power on and power off so that the operational mistake can be eliminated.

Furthermore, an incident power off (such as battery failure or abnormal power shutdown) during an operation is also taken into consideration for ensuring the safety.

### SUMMARY OF THE PRESENT INVENTION

Accordingly, the primary object of the present invention is to provide a rotary mechanism lock capable of lock the rotary mechanism during power off and providing an anti-lock function for an incident power off. The present invention can be applied to beach buggy, golf cart, electric cart, and any other devices requiring for the functions described in the following.

1. The rotary mechanism can be locked automatically after a power off is applied so as to prevent further movement (instead of hand brake for a vehicle).
2. The rotary mechanism will not be locked while the rotational speed exceeding a predetermined value under incident power off. The rotary mechanism will not be locked until the rotational speed dropping below the predetermined value.

To achieve the above objectives, the present invention includes a rotor, stator, stopper arranged to the stator for travelling between a lock and release position against the rotor, a clutch serving to control the stopper, and an anti-lock unit for suppressing stopper from moving during an incident power off.

The clutch is activated by turning on the power to drive the stopper away to disengage and release the rotor.

The clutch will release the stopper so that the stopper can engage and lock the rotor after power is turned off.

The anti-lock will move to block the stopper from engaging the rotor while the rotational speed of the rotor exceeding a predetermined value. The anti-lock will release the stopper automatically while the rotational speed of the rotor dropping below the predetermined value.

Through the above components, the title can actually lock and release the rotary mechanism under a power off and power on respectively. Under a suddenly power off during operation, the title will lock the rotary mechanism at a predetermined rotational speed to prevent damage to the mechanism and ensure the safety.

### BRIEF DESCRIPTION OF THE DRAWINGS

FIG. 1 is a perspective view showing the operation of the present invention during power off.

FIG. 2 is a perspective view showing the operation of the present invention during power on.

FIG. 3 is a perspective view showing the operation of the present invention during an abnormal shutdown.

FIG. 4 is a schematic view showing a transmission shaft of the invention.

FIG. 5 is a cross-section view through a 5-5 line illustrated in FIG. 4.

FIG. 6 is a cross-section view through a 6-6 line illustrated in FIG. 4.

FIG. 7 is a schematic view showing a control shaft of the transmission shaft of the present invention.

FIG. 8 is a cross-section view through an 8-8 line illustrated in FIG. 7.

FIG. 9 is a top view showing a transmission wheel of the invention.

FIG. 10 is a cross-section view through a 10-10 line illustrated in FIG. 9.

FIG. 11 is a top view showing a rotor of the present invention.

FIG. 12 a side view showing the rotor of the present invention.

FIG. 13 is a top view of the FIG. 12.

FIG. 14 is a top view showing a clutch of the present invention.

FIG. 15 is a side view showing the clutch of the present invention.

FIG. 16 is a cross-section view through a 16-16 line of the FIG. 14.

FIG. 17 is a top view showing a stopper of the present invention.

FIG. 18 is a side view showing the stopper of the present invention.

FIG. 19 is a bottom view of the stopper of the present invention.

FIG. 20 is across-section view through a 20-20 line in FIG. 17.\FIG. 21 is a schematic view showing the installation of an anti-lock of the present invention.

FIG. 21 is a schematic view of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

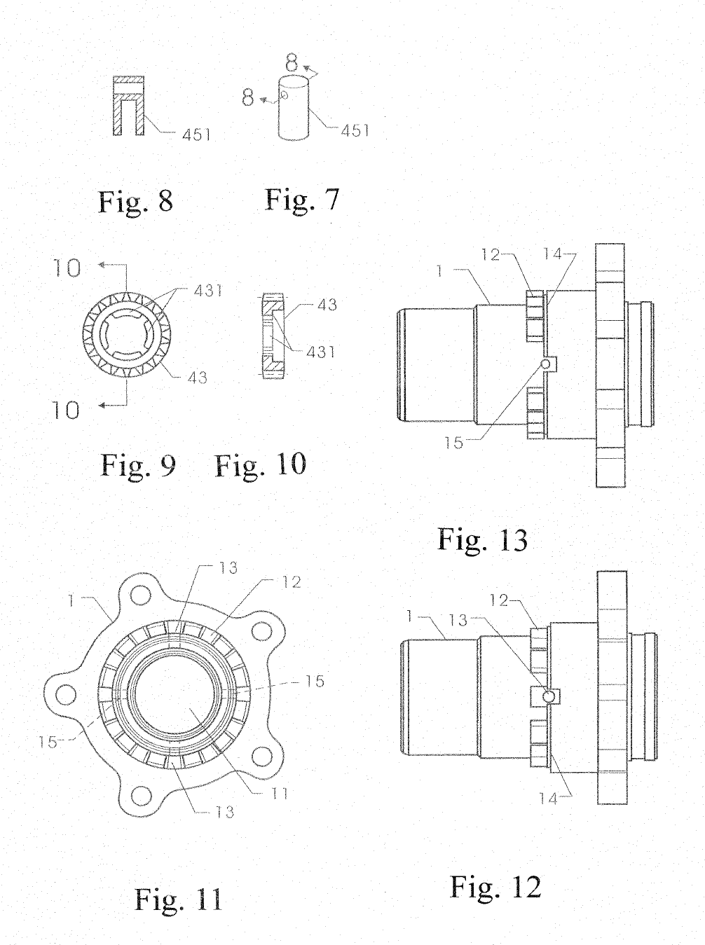

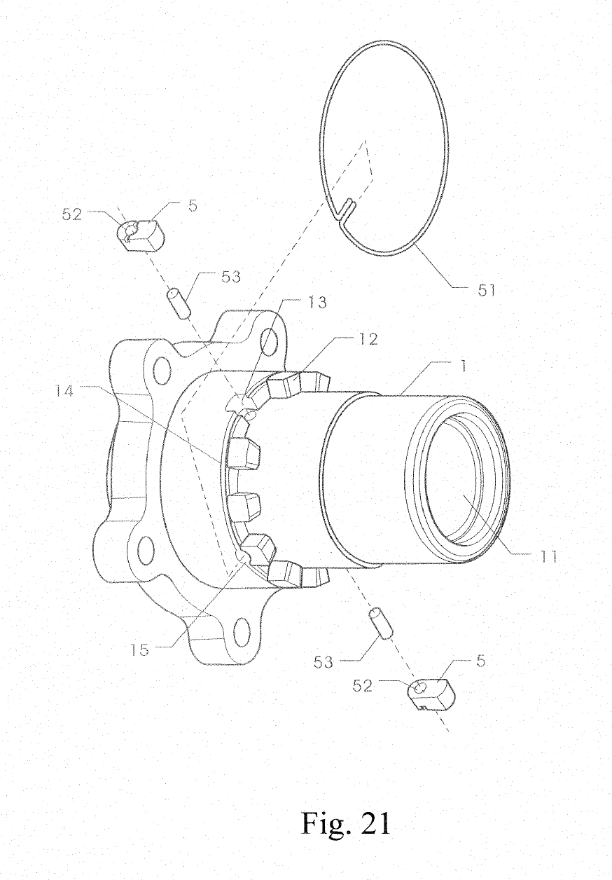

A preferable embodiment of an auto-lockup and anti-lock device for rotary mechanism according to the present invention is illustrated in the FIGS. 1 to 21. The present invention can be widely applied to beach cart, golf cart, electric cart, and other electric rotary mechanism requiring the relative functions.

The auto-lockup and anti-lock device for rotary mechanism of the present invention includes a rotor 1, stator 2, stopper 3 arranged to the stator 2 for travelling between a lock and release position against the rotor 1, a clutch 4 serving to control the stopper 3, and an anti-lock unit 5 for suppressing stopper 3 from moving during an incident power off.

The rotor 1 is a hollow cylinder as shown in FIGS. 11 to 13. The rotor 1 has an axle hole 11 for linking an external rotary mechanism such as a rotary shaft. A retaining portion 12 is formed around the peripheral of the rotor 1. A plurality of protruding tooth annular arranged through the retaining portion 12. At least one notch 13 for arranging the anti-lock unit 5 is arranged to the retaining portion 12. A groove 14 for retaining a spring 51 for retaining the anti-lock unit 5 is formed around the retaining portion 12. A positioning hole 15 for positioning the spring 51 is formed to the retaining portion 12.

A stator 2 of the present invention is illustrated in FIGS. 1 to 3. The stator 2 is fixed against the rotor 1. A guiding groove 21 is formed to an inner wall of the stator 2 for guiding the stopper 3 traveling linearly through a specific direction. A guide pin 22 is arranged to the stator 2, and the guide pin 22 is received by a positioning hole 31 of the stopper 3. During the traveling, the stopper 3 slides through the guide pin 22 and a spring 23 arranged to the guide pin 22 can provide a restoring force to the stopper 3.

The stopper 3 is a ring body as shown in FIGS. 17 to 20. The stopper 3 has a large periphery and a small periphery. Guiding teeth 32 are formed around the large peripheral of the stopper 3 for engaging the guiding groove 21. At least one guide hole 31 is formed to a lateral side of the large peripheral of the stopper 3 for receiving the guide pin 22 and the spring 23. A circular groove 33 is formed to another lateral side of the large peripheral of the stopper 3 for engaging the clutch 4. A plurality of retaining slot 34 is formed to an inner wall of the small peripheral for engaging the retaining portion 12 of the rotor 1.

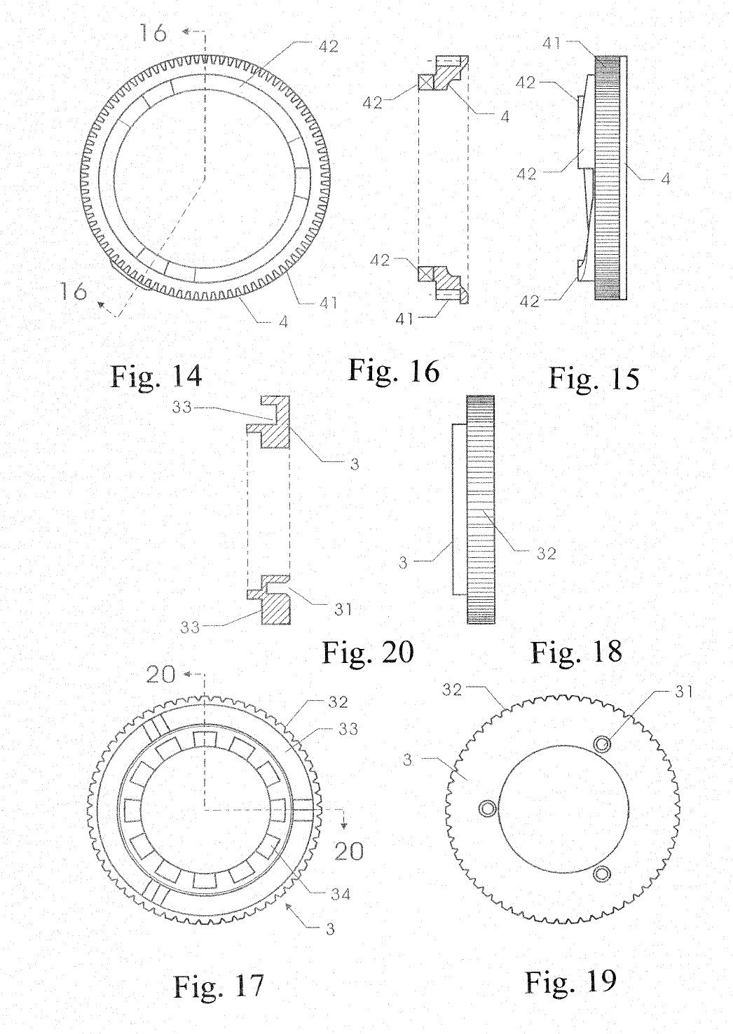

The clutch 4 is a ring body as shown in FIGS. 14 to 16. The clutch 4 has a large peripheral and a small peripheral. A plurality of tooth 41 is formed around the large peripheral to engage a transmission wheel 43. A plurality of ramp 42 is formed to the lateral side of the small peripheral. The ramp 42 serves to engage the circular groove 33 of the stopper 3. The transmission wheel 43 is arranged to a transmission shaft 44. The transmission wheel 43 has a clutch portion 431 on a wall of an axial hole thereof. The clutch portion 431 has at least one pair of protruded block as shown in FIGS. 9 to 10. The clutch portion 431 is formed to a side of the axial hole, a predetermined gap is formed between the opposite protruded block so that a clutch unit 45 can move in and out.

Referring to FIGS. 4 to 6, the transmission shaft 44 for linking the transmission wheel 43 and the clutch unit 45 is illustrated. Transmission teeth 441 are formed around a peripheral of the transmission shaft 44 to be driven to rotate. An upper portion of the transmission shaft 44 serves to link the transmission wheel 43. A spring 46 is arranged between the transmission wheel 43 and the transmission shaft 44 to retrieve the transmission wheel 43 after the transmission wheel 43 is rotated. The clutch unit 45 is arranged between the transmission shaft 44 and the transmission wheel 43 to engage and disengage the linking of the transmission shaft 44 and the transmission wheel 43. The clutch unit 45 is operated by a control shaft 451 so as to control the clutch unit 45 to engage and disengage the clutch portion 431 of the transmission wheel 43.

The anti-lock 5 is a block having a through hole 52 for receiving a positioning column 53. The positioning column 53 penetrating the anti-lock 5 is inserted into the notch 13 of the rotor 1. The anti-lock 5 is elastically tied by a spring 51 within the notch 13 of the rotor 1 so that the anti-lock 5 will be spun out of the notch 13 while the rotor reaching a predetermined rotational speed. The anti-lock 5 will return into the notch 13 automatically under the predetermined speed.

The operations of the present invention are illustrated in FIGS. 1 to 3.

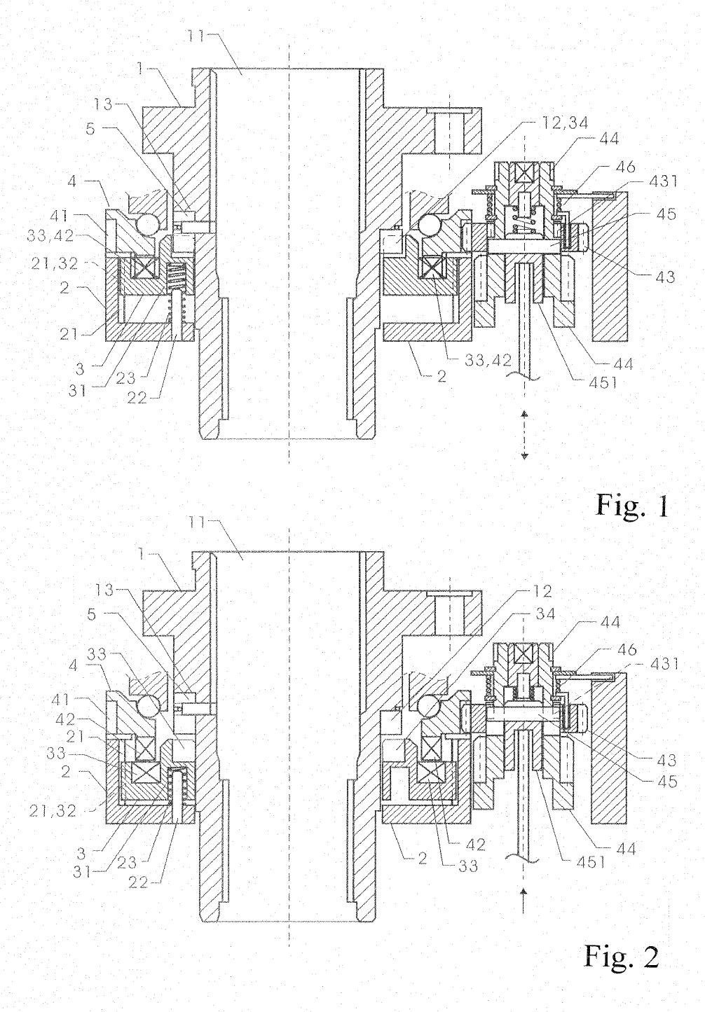

Referring to FIG. 2, the transmission shaft 44 is driven by an external power such as a motor. Through the control shaft 451, the clutch unit 45 of the transmission shaft 44 will engage the clutch portion 431 of the transmission wheel 43 so that the transmission wheel 43 can rotate the clutch 4 to escape the stopper 3 from the rotor 1. Thus, the rotor 1 is free to rotate.

Referring to FIG. 1, the control shaft 451 will separate the clutch unit 45 from the clutch portion 431 of the transmission wheel 43 while the external power was shut. The transmission wheel 43 will be retrieved by the spring 46 and rotate the clutch 4. The stopper 3 will be pushed by the spring 23 to engage the rotor 1 to freeze the rotor 1.

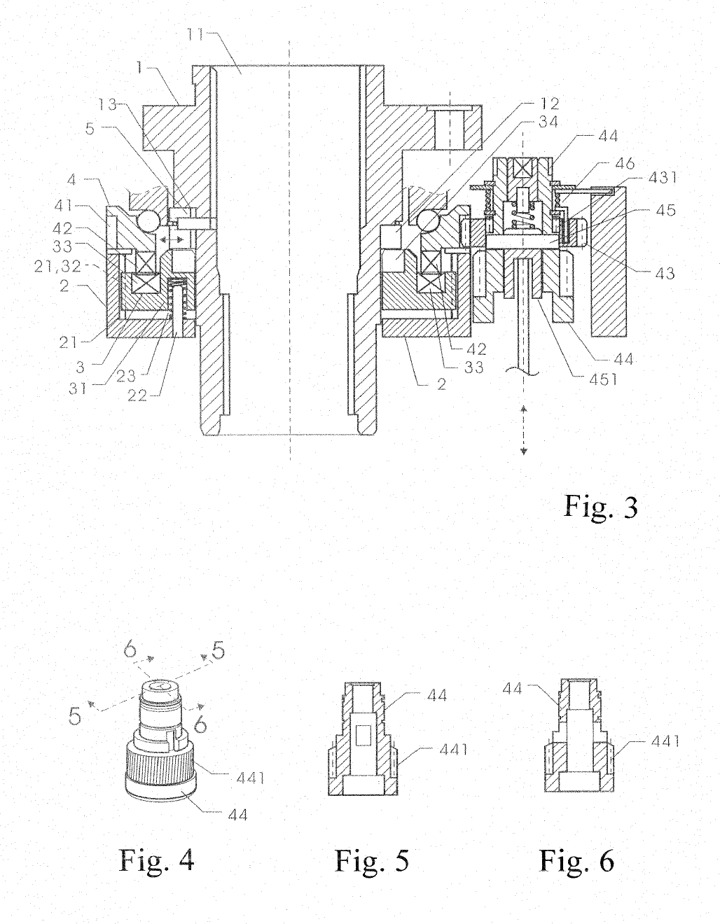

Referring to the FIG. 3, the anti-lock 5 arranged to the rotor 1 will be spun out of the notch 13 while the rotational speed of the rotor 1 exceeding the predetermined speed so as to prevent the stopper 3 from engaging the rotor 1. When an abnormal power off happened during rotation, the anti-lock 5 can prevent the stopper 3 moving until the rotational speed dropping below the predetermined value.

Through the above operation of the present invention, the auto-lockup and anti-lock device for rotary mechanism can actually lock and release the rotary mechanism under a power off and power on respectively. Under a suddenly power off during operation, the anti-lock will not lock the rotary mechanism until a predetermined rotational speed to prevent damage to the mechanism and ensure the safety.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An auto-lockup and anti-lock device for rotary mechanism comprising:
a rotor rotating relative to a stator;
the stator being fixed against the rotor;
a stopper arranged to the stator serving to lock and release the rotor;
a clutch serving to move the stopper;
an anti-lock locking the stopper during an abnormal operation;
wherein the clutch is activated to drive the stopper away to disengage and release the rotor during power on; the clutch will drive the stopper to engage and lock the rotor during a power off; however, the anti-lock will move to block the stopper from engaging the rotor while the rotational speed of the rotor exceeding a predetermined value; the anti-lock will release the stopper automatically while the rotational speed dropping below the predetermined value.

2. The auto-lockup and anti-lock device for rotary mechanism as claimed in claim 1, wherein the rotor is a hollow cylinder; a retaining portion is formed around a peripheral of the rotor; the retaining portion has a plurality of protruding tooth; at least one notch for arranging the anti-lock is arranged to the retaining portion; a groove for retaining a spring for pushing the anti-lock back into the notch is formed around the retaining portion; a positioning hole for positioning the spring is formed to the retaining portion; the anti-lock is a block having a through hole for receiving a positioning column; the positioning column penetrating the anti-lock is inserted into the notch and the anti-lock is suppressed by the spring.

3. The auto-lockup and anti-lock device for rotary mechanism as claimed in claim 1, wherein the stator is fixed against the rotor; a guiding groove is formed to an inner wall of the stator for guiding the stopper traveling linearly through a specific direction; a guide pin is arranged to the stator for being received by a positioning hole of the stopper; the guide pin has a spring to push against the stopper; the stopper has a large periphery and a small periphery; guiding teeth are formed around the large peripheral of the stopper for engaging the guiding groove of the stator; at least one positioning hole is formed to a lateral side of the large peripheral of the stopper for receiving the guide pin and the spring; a circular groove is formed to another lateral side of the large peripheral of the stopper for engaging the clutch; a plurality of retaining slot is formed to an inner wall of the small peripheral for engaging the retaining portion of the rotor; the clutch has a large peripheral and a small peripheral; a plurality of tooth is formed around the large peripheral to engage a transmission wheel; a plurality of ramp is formed to the lateral side of the small peripheral; the ramp serves to engage the circular groove of the stopper.

4. The auto-lockup and anti-lock device for rotary mechanism as claimed in claim 1, wherein the transmission wheel is arranged to a transmission shaft; the transmission wheel has a clutch portion on a wall of an axial hole thereof; the clutch portion has at least one pair of protruded block; the clutch portion is formed to a side of the axial hole, and a predetermined gap is formed between the adjacent protruded block for allowing a clutch unit moving in and out; the transmission shaft for linking the transmission wheel and the clutch unit is rotated by an external mechanism; a plurality of transmission tooth is formed around a peripheral of the transmission shaft to be driven to rotate; an upper portion of the transmission shaft serves to link the transmission wheel; a spring is arranged between the transmission wheel and the transmission shaft to rotately retrieve the transmission wheel; the clutch unit is arranged between the transmission shaft and the transmission wheel to engage and disengage the linking of the transmission shaft and the transmission wheel; the clutch unit is operated by a control shaft.

5. An auto-lockup device for rotary mechanism comprising:
a rotor rotating relative to a stator;
the stator being fixed against the rotor;
a stopper arranged to the stator serving to lock and release the rotor;
a clutch serving to move the stopper;
wherein the clutch is activated to drive the stopper away to disengage and release the rotor during power on; the clutch will drive the stopper to engage and lock the rotor during a power off.

6. The auto-lockup device for rotary mechanism as claimed in claim 5, wherein the rotor is a hollow cylinder; a retaining portion is formed around the peripheral of the rotor; the retaining portion has a plurality of protruding tooth.

7. The auto-lockup device for rotary mechanism as claimed in claim 5, wherein the stator is fixed against the rotor; a guiding groove is formed to an inner wall thereof for guiding the stopper traveling linearly through a specific direction; a guide pin is arranged to the stator for being received by a positioning hole of the stopper; the guide pin has a spring to push against the stopper; the stopper has a large periphery and a small periphery; guiding teeth are formed around the large peripheral of the stopper for engaging the guiding groove of the stator; at least one positioning hole is formed to a lateral side of the large peripheral of the stopper for receiving the guide pin and the spring; a circular groove is formed to another lateral side of the large peripheral of the stopper for engaging the clutch; a plurality of retaining slot is formed to an inner wall of the small peripheral for engaging the retaining portion of the rotor; the clutch has a large peripheral and a small peripheral; a plurality of tooth is formed around the large peripheral to engage a transmission wheel; a plurality of ramp is formed to the lateral side of the small peripheral; the ramp serves to engage the circular groove of the stopper.

8. The auto-lockup device for rotary mechanism as claimed in claim 5, wherein the transmission wheel is arranged to a transmission shaft; the transmission wheel has a clutch portion on a wall of an axial hole thereof; the clutch portion has at least one pair of protruded block; the clutch portion is formed to a side of the axial hole, and a predetermined gap is formed between the adjacent protruded block for allowing a clutch unit moving in and out; the transmission shaft for linking the transmission wheel and the clutch unit is driven by an external mechanism; a plurality of transmission teeth is formed around a peripheral of the transmission shaft to be driven to rotate; an upper portion of the transmission shaft serves to link the transmission wheel; a spring is arranged between the transmission wheel and the transmission shaft to rotately retrieve the transmission wheel; the clutch unit is arranged between the transmission shaft and the transmission wheel to engage and disengage the linking of the transmission shaft and the transmission wheel; the clutch unit is operated by a control shaft.

9. An anti-lock device for an auto-lockup rotary mechanism comprising:
a rotor and an anti-lock for preventing the rotor from being locked during an incident power off;
Wherein the anti-lock will move to block the stopper from engaging the rotor while the rotational speed of the rotor exceeding a predetermined value; the anti-lock will release the stopper automatically while the rotational speed dropping below the predetermined value.

10. The title as claimed in claim 9, wherein the rotor is a hollow cylinder; a retaining portion is formed around the peripheral of the rotor; the retaining portion has a plurality of protruding tooth; at least one notch for arranging the anti-lock is arranged to the retaining portion; a groove for retaining a spring for pushing the anti-lock back into the notch are formed around the retaining portion; a positioning hole for positioning the spring is formed to the retaining portion; the anti-lock is a block having a through hole for receiving a positioning column; the positioning column penetrating the anti-lock is inserted into the notch and the anti-lock is retaining by the spring.
